(19) United States
(12) Patent Application Publication
(10) Pub. No.: US 2008/0103950 A1
(43) Pub. Date: May 1, 2008

(54) SYSTEM AND METHOD FOR SMOOTHING FINANCIAL DATA

(75) Inventor: Timothy S. Mather, Englewood, CO (US)

Correspondence Address: FAEGRE & BENSON LLP;PATENT DOCKETING, 2200 WELLS FARGO CENTER, 90 SOUTH SEVENTH STREET, MINNEAPOLIS, MN, 55402-3901, US

(73) Assignee: CQGT,LLC

(21) Appl. No.: 11/875,435

(22) Filed: Oct. 19, 2007

Related U.S. Application Data
(60) Provisional application No. 60/855,265, filed on Oct. 30, 2006.

(51) Int. Cl. G06Q 40/00; G06F 17/40; G06F 19/00

(52) U.S. Cl. 705/35

(57) ABSTRACT

Systems and methods for aggregating groups of input financial data such that the aggregated data reflects trends more smoothly than the input financial data are provided. More specifically, various methods and systems of the present invention provide for aggregating one or more selected data points from a set of input data points into an aggregated data point, wherein each data point includes at least a high value and a low value. The aggregated data may be presented in various ways to visually depict trends in the data. For example, in the case of a price bar chart, one or more input price bars can be aggregated into a single price bar, with the effect that jumpiness or noise that might exist in the input price bar(s) is removed by the presentation of the single aggregated price bar.

### CROSS-REFERENCE TO RELATED APPLICATIONS

This application claims the benefit of Provisional Application No. 60/855,265, filed on Oct. 30, 2006, which is hereby incorporated by reference in its entirety for all purposes.

### COPYRIGHT NOTICE

Contained herein is material that is subject to copyright protection. The copyright owner has no objection to the facsimile reproduction of the patent disclosure by any person as it appears in the Patent and Trademark Office patent files or records, but otherwise reserves all rights whatsoever. Copyright© 2006-2007 CQGT, LLC.

### TECHNICAL FIELD

Various embodiments of the present invention generally relate to the presentation of financial information. More specifically, embodiments of the present invention relate to systems and methods for smoothing financial data.

### BACKGROUND

In the field of financial trading, trading of financial instruments (e.g., securities, commodity, currency, or index futures, options, etc.) is typically done today through an electronic exchange, rather than on the historical “trade floor”. Trading through an electronic exchange enables virtually anyone with a computer to trade directly with the exchange. Via a trader's computer that accesses the exchange over a network, the trader can obtain real-time or historical financial data, place trade orders (e.g., bids and asks), perform a wide range of financial analyses, and much more. In addition, data can be presented to the trader in various useful formats, such as graphical or alphanumeric. The types of data presented, the manner and timeliness of presentation, and the data manipulations performed by the trader's financial application are important factors that can more or less improve the trader's ability to make informed decisions and profit in the market.

For example, financial data may be presented in the form of a bar chart. Conventionally, a price bar chart includes a vertical line (a bar) representing the range of prices spanned for a security in a unique time period of trading. The top of the vertical line indicates the highest price a security traded at during unique time period, and the bottom represents the lowest price. A closing price for the unique time period may be displayed on the right side of the bar, and an opening price for the unique time period may be shown on the left side of the bar. While conventional methods for generating and presenting bar charts can be useful, the bars are often generated and presented in a way that captures “noise” in the market, rather than overall trends. For example, a series of bars in the bar chart may jump up and down in the very short term as they generally trend up or down. Often the trader is not as interested in the immediate jumps, but is interested in the longer term trend up or down. Unfortunately, data considered over a very short term often jumps up and down, which resembles noise, and can be distracting and not highly informative to the trader.

It is with regard to these and other problems that embodiments of the present invention have been developed.

### SUMMARY

Systems and methods are described for smoothing financial data. In some embodiments, systems and methods for aggregating groups of input financial data such that the aggregated data reflects trends more smoothly than the input financial data are provided. Various embodiments use a method for aggregating price data of a financial instrument that includes receiving a set of financial data points, selecting a reference set, defining smoothing aggregation parameters, and selecting a series of consecutive financial data points subsequent to the reference set. In some of these embodiments, a new aggregated data point is generated whenever an input data point is identified to have a high value and/or a low value out of the range of the maximum and minimum values of reference set.

According to various embodiments, a data set of order and trade information may be received from an electronic exchange or a set of financial data points may be received from a historical database or pre-processing application. If a data set of order and trade information is received, the order and trade information can then be used to generate a set of financial data points. In some embodiments, a set of financial data points for a financial instrument are received from an external source or an internal source such as a financial data point generation module. The financial data points each include a low price and high price for the financial instrument.

Once some data points are received or computed, a reference set can be selected which includes a subset of the financial data points. In some embodiments, smoothing aggregation parameters are defined based on one or more properties of the selected reference set of financial data points. For example, the smoothing aggregation parameters may include an aggregation range. A series of consecutive financial data points subsequent to the reference set is then selected. In at least one embodiment, the series of consecutive financial data points is defined by consecutive financial data points subsequent to the reference set that fall inside the defined smoothing aggregation parameters.

In some embodiments, an aggregated data point is generated based on the selected series of consecutive financial data points. A graphical representation of the aggregated data point may be displayed on a chart.

While multiple embodiments are disclosed, still other embodiments of the present invention will become apparent to those skilled in the art from the following detailed description, which shows and describes illustrative embodiments of the invention. As will be realized, the invention is capable of modifications in various aspects, all without departing from the scope of the present invention. Accordingly, the drawings and detailed description are to be regarded as illustrative in nature and not restrictive.

### BRIEF DESCRIPTION OF THE DRAWINGS

FIG. 1 illustrates an example of an operating environment in which embodiments of the present invention may operate.

FIG. 2 illustrates a price bar chart including input price bars in accordance with various embodiments of the present invention.

FIG. 3 illustrates another price bar chart including aggregated price bars in accordance with one or more embodiments of the present invention.

FIG. 4 illustrates an aggregated data table including aggregated data points corresponding to a portion of the aggregated price bars of FIG. 3.

FIG. 5 illustrates the price bar chart from FIG. 2 with markings indicating the range of input data points used to construct a portion of the aggregated price bars of FIG. 3.

FIG. 6 illustrates a table including the input data points corresponding to a portion of the input price bars of FIG. 5, rolling maximum and minimum values, and some aggregated data points generated using the input data points and corresponding to a portion of the aggregated price bars of FIG. 3.

FIG. 7 illustrates zoomed-in portions of the input price bar chart of FIG. 2 and of the aggregated price bar chart of FIG. 3 to depict how selected input price bars can be aggregated into an associated aggregated price bar in FIG. 4 in accordance with some embodiments of the present invention.

FIG. 8 illustrates a user interface for selecting a type of aggregation in accordance with embodiments of the present invention.

FIG. 9 is a flowchart illustrating an example of a process to carry out smoothing aggregation in accordance with various embodiments of the present invention.

FIG. 10 illustrates an example of a computing device upon which embodiments of the present invention can operate.

### DETAILED DESCRIPTION

In general, embodiments of methods and systems are described for aggregating groups of input financial data such that the aggregated data reflects trends more smoothly than the input financial data. More specifically, methods and systems provide for aggregating one or more selected data points from a set of input data points into an aggregated data point, wherein each data point includes at least a high value and a low value. The aggregated data may be presented in various ways to visually depict trends in the data. For example, in the case of a price bar chart, one or more input price bars (also referred to as “input bars”) can be aggregated into a single aggregated price bar, with the effect that jumpiness or noise that might exist in the input price bar(s) is removed by the presentation of the single aggregated price bar (also referred to as an “aggregated bar”).

In various embodiments, a set of input financial data points are received. Each financial data point includes at least a high value and a low value. The set of data points typically corresponds to prices of a financial instrument during a discrete period of time. For example, the high value typically corresponds to the highest price of the financial instrument within a period of time, and the low value typically corresponds to the lowest price of the financial instrument within the period. The input data points are typically serially generated over time, and each input data point is associated with a unique period of time.

In accordance with some embodiments, a specified number of input data points are aggregated into one aggregated data point that has a high value equal to the highest value among the specified number of input data points, and a low value equal to the lowest value among the specified number of input data points. In some of these embodiments, a new aggregated data point is generated whenever an input data point is identified subsequent in time to a reference set of input data points, which has a high value or a low value out of the range of the high and low values of the current aggregated data point.

Embodiments of a method include determining whether a selected input data point is within a range defined by a set of reference data points, and if the input data point is within the range, aggregating the input data point with the reference data points. The method may further include generating and displaying an aggregated price bar chart including price bars depicting a plurality of aggregated data points.

Determining whether an input data point is within the range defined by the set of reference data points can include determining whether the high value of the input data point is not greater than the highest value of the reference data points and determining whether the low value of the input data point is not less than the lowest value of the reference data points. Aggregating can include generating a single aggregated data point that represents the reference data points and one or more input data points between the selected input data point and the reference data points. For example, the generated aggregated data point may have a high value equal to a high value of the reference set of input data points and a low value equal to a low value of the reference set of input data points. As another example, aggregating may also include replacing input data points that are to be aggregated with the single aggregated data point.

Various embodiments relate to a system configured to generate one or more aggregated data points based on a plurality of input data points. The system generates an aggregated data point when a trend extension or trend reversal is identified in the input data points. A trend extension or trend reversal may be identified by comparing a high value and a low value of an input data point selected from the plurality of input data points with a high value and a low value, respectively, of a reference set of input data points prior to the selected input data point. If the high value of the selected input data point is greater than the high value of the reference set of input data points or the low value of the selected input data point is less than the low value of the reference set of input data points, then it is determined that the trend has been extended or has reversed.

Once a trend extension or trend reversal is identified, the aggregated data point may be generated in such a way that the aggregated data point represents and/or replaces one or more input data points in the reference set of input data points and the input data points between the reference set of input data points and the selected input data point. In accordance with one or more embodiments of the system, the system is configured to enable a user to set the number of data points to be included in the reference set. The system may be further configured to generate a plurality of aggregated data points based on a plurality of input financial data points (e.g., data points for financial instruments), and present the plurality of aggregated data points through an output device. For example, the plurality of aggregated data points may be displayed as financial price bars on a computer monitor.

In at least one embodiment, in the context of a financial price bar chart, smoothing aggregation can cause one or more price bars in a set of input price bars to resolve into a single aggregated price bar, wherein each aggregated price bar has a high value and a low value. Aggregating one or more of the input data points involves selecting one of the input data points as a starting data point. A reference set of input data points around the starting data point is analyzed to determine an aggregation range that is used to aggregate input data points. The aggregation range has a high value equal to the highest value among the reference set of input data points and a low value equal to the lowest value among the reference set of input data points. After the aggregation range is determined, an input data point subsequent in time to the reference set is selected for aggregation if its high value and its low value fall within the aggregation range. If the high value or the low value of an input data point subsequent in time to the reference set falls outside the aggregation range, a new reference set of input data points is analyzed to determine the aggregation range for the new aggregated data point. This operation of creating aggregated data points from input data points is repeated iteratively as new input data points are retrieved from a historical record of financial transactions or received from a real-time stream.

In accordance with some embodiments, minimum and maximum values for a rolling window of input data points after the selected starting point are continuously analyzed to establish a low value and a high value for each reference set of input data points. In these embodiments, the user may specify a number of data points to include in each reference set of input data points. Given a plurality of input data points, the input data points are taken n at a time, where n is the number specified by the user. After a first set of n input data points is analyzed, then another n input data points in the plurality of input data points is analyzed, and so on. This analysis process may be viewed as applying a rolling window over n data points at a time through the plurality of data points.

In addition to analyzing the reference set of input data points to determine the high value and low value, each input data point is analyzed to determine whether the high value or the low value are outside of the most recent aggregation range. More specifically, when an input data point is analyzed that has a high value greater than the high value of the most recent of the most recent aggregation range or a low value that is less than the low value of the most recent of the most recent aggregation range, an aggregated data point is created that represents one or more input data points of the reference set and one or more additional input data points that have a high value and a low value within the range of the of the most recent aggregation range. In addition the aggregation range for the next aggregated data point is established from most current reference data set.

According to some embodiments, the input data points may include trade volumes in which case the aggregated data point may also include trade volume information. For example, the trade volume included in the aggregated data point may be computed by summing the trade volumes associated with each input data point contributing to the aggregated data point. In one or more embodiments, the bar representing the aggregated data point may be of varying width proportional to it relative trade volume or may be marked in an manner representative of the ratio of the bid trade volume to the ask trade volume using colors, graphical patterns or another appropriate mechanism.

Terminology

Brief definitions of terms used throughout this application are given below.

The phrase “bar chart” refers to a graph with one or more bars that share a common horizontal scale. Each bar may represent one or more data points and may have one or more independent value scales.

The terms “connected” or “coupled” and related terms are used in an operational sense and are not necessarily limited to a direct connection or coupling.

The term “financial instrument” generally refers to anything that can be traded with quantities and/or prices. Examples of financial instruments include, but are not limited to, securities, commodities, currency, stocks, bonds, mutual funds, Exchange-Traded Funds (EFTs), stock futures, index futures, commodity futures, stock options, commodity options and the like.

The term “embodiment,” “according to various embodiments,” and the like generally mean the particular feature, structure, or characteristic following the phrase is included in at least one embodiment of the present invention, and may be included in more than one embodiment of the present invention. Importantly, such phases do not necessarily refer to the same embodiment.

The phrase “price bar” for a particular financial instrument generally refers to the graphical representation of a data entity that includes at least two price values: a high price, which is the highest price registered for the discrete duration of the bar; and a low price, which is the lowest price registered for the discrete duration of the bar. A price bar may include an open price, which is the first price registered; and a close price, which is the last price registered for the discrete duration of the bar. Prices considered in constructing the data entity may include bids, ask, and trades or just trades exclusively.

The term “responsive” includes completely and/or partially responsive.

The term “trader” generally refers to any person, electronic device, and/or mechanical device that uses an input device, computerized or otherwise, to place trade orders, either to buy or to sell a specific quantity of a financial instrument, into a market place.

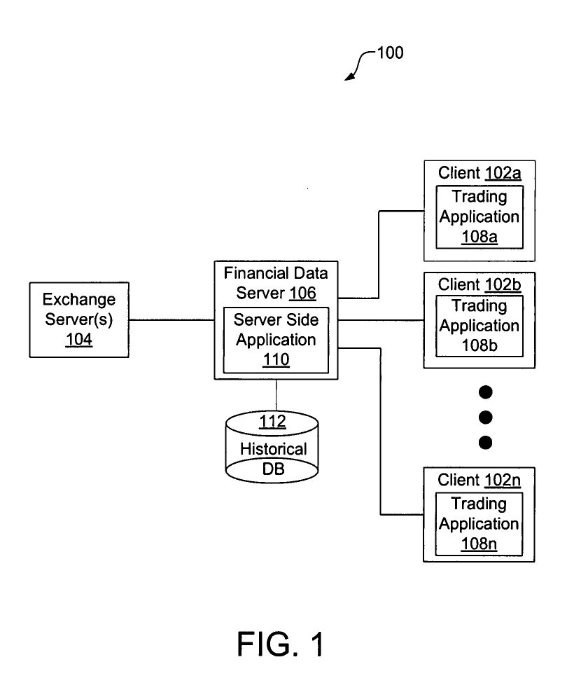

FIG. 1 illustrates an example of an operating environment 100 in which embodiments of the present invention may be employed (and/or be a part of, in whole or part). One or more traders use client computers or terminals 102a-n to analyze data and place trade orders at electronic exchange server(s) 104. The electronic exchange server(s) 104 are servers associated with the electronic exchange that accept trade orders, provide requested data, provide a substantially real-time stream of bid, ask, and trade prices and volumes, and other data manipulation related to the electronic exchange. The clients 102a-n communicate with a financial data server 106 that facilitates communication of financial data and placement of trade orders.

Trading applications 108a-n operate on clients 102a-n, respectively. Trading applications 108a-n each gather financial data, process the data, present selected data to the trader on a display (not shown), receive input from the trader, and transmit trade orders to the server 106. More specifically, the trading applications 108a-n communicate with a server side application 110. The server side application 110 is operable to obtain selected data from the exchange server(s) 104 and communicate data to the exchange server(s) 104. Data communicated to the exchange server(s) 104 may be, for example, elements of trade orders, such as buy or sell, quantity, stop or limit prices, or others.

In the embodiment shown, financial data server 106 utilizes a database 112 for storing data, such as historical price and volume data. Server application 110 and client applications 108a-n can use and present real-time data and historical data from historical database 112. The database 112 may store data in any form suitable for the particular implementation, such as, but not limited to, a relational database and flat files. As such, the database 112 may or may not be accessed via a structured query language (SQL), for example. In addition, financial data server 106 can include cache memory (not shown) for caching selected data, which may be used again later. The server 106 may at times remove selected data from the cache, based on caching rules.

In some embodiments, clients 102a-n can subscribe to selected financial instruments, and financial information, or services. Clients 102a-n, financial data server 110, and exchange server(s) 104 communicate via one or more networks. The networks may be wireless, wired, or a combination of wired and wireless. Network components (not shown) and/or components at the clients 102a-n, financial data server 110, and exchange server 104, such as firewalls and network address translators (NATs), may provide for data and system security.

Data communicated between the clients 102a-n and the financial data server 106, and between the financial data server 106 and the exchange server(s) 104 may be “pushed” or “pulled”, or any combination thereof, depending on the situation. For example, akin to pulling, the client 102a may request historical data from the financial data server 106, which will prompt the server side application 110 to retrieve the requested data from the database 112 and send the data to the client 102a. On the other hand, real-time data from the exchange server(s) 104 is typically pushed to one or more of the clients 102a-n by the server side application 110.

One or more embodiments described herein relate to smoothing aggregation systems and methods for aggregating a plurality of input data points. These embodiments are described using price bar charts for illustration. It will be understood by those skilled in the art that the aggregation systems and methods can be applied to any set of input data points, regardless of what the data points represent or how the data points are presented. For example, the data points could be displayed in a line chart rather than a bar chart. As another example, the data points could represent vehicle traffic over various time periods throughout the day, rather than financial data. As such, the embodiments described herein are merely for convenience of illustration and are not intended to limit the scope of the invention.

In general, embodiments of the present invention operate on a plurality of input data points. The input data points may be input into the aggregation system in a substantially real time manner or in one or more batches. Input financial data points and input price bars may be generated in numerous different ways. Some techniques for generating a plurality of input data points are described in co-pending, co-owned U.S. patent application Ser. No. 11/531,397, filed on Sep. 13, 2006, entitled “System and Method for Determining Data Points for Financial Bar Charts and Their Presentation”, which is hereby incorporated by reference in its entirety for all purposes. However, numerous other ways to generate input data points that can be aggregated according to embodiments described herein are also contemplated.

In general, embodiments of the present invention provide that each data point has at least two values. These two values are referred to herein as a high value and a low value. In terms of financial data, the high value represents the high price of a financial instrument within a period of time (e.g., 1 minute) and the low value represents the low price of the financial instrument during the corresponding period of time.

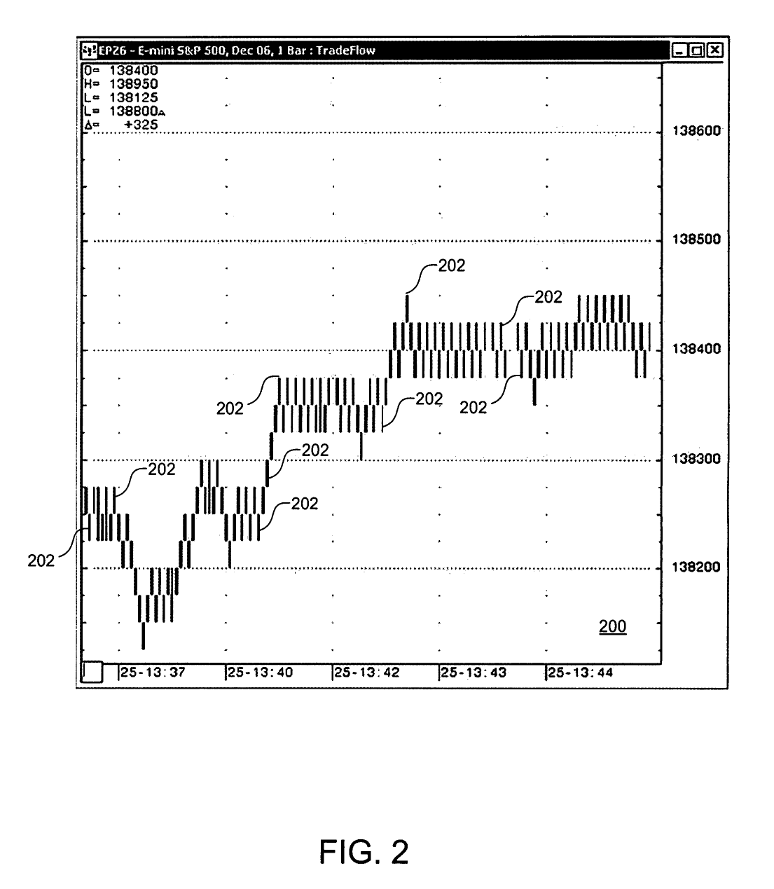

FIG. 2 illustrates a snapshot of a graphical user interface including price bar chart 200. The bar chart includes a plurality of price bars 202 depicting ranges of prices for a selected financial instrument at different periods of time. The price bars 202 in FIG. 2 are referred to as “input bars” and the price data points depicted by the input bars are referred to as “input data points”. Such input data points and input bars may be generated using methods described in the above referenced patent application entitled “System and Method for Determining Data Points for Financial Bar Charts and Their Presentation”, or other methods.

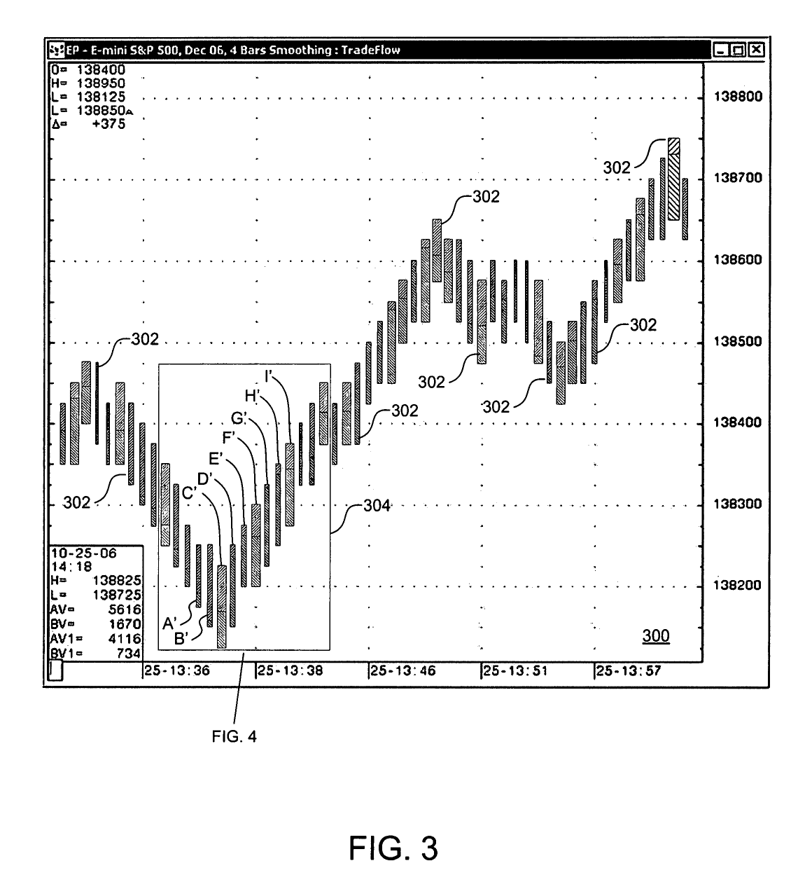

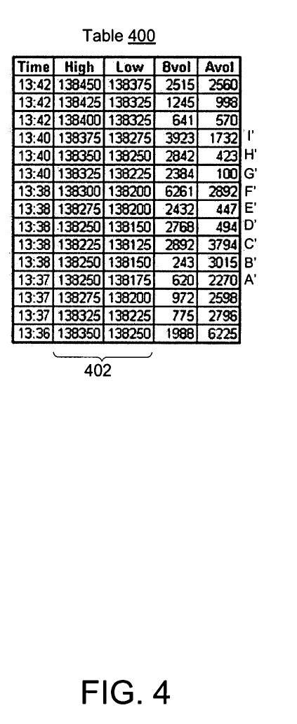

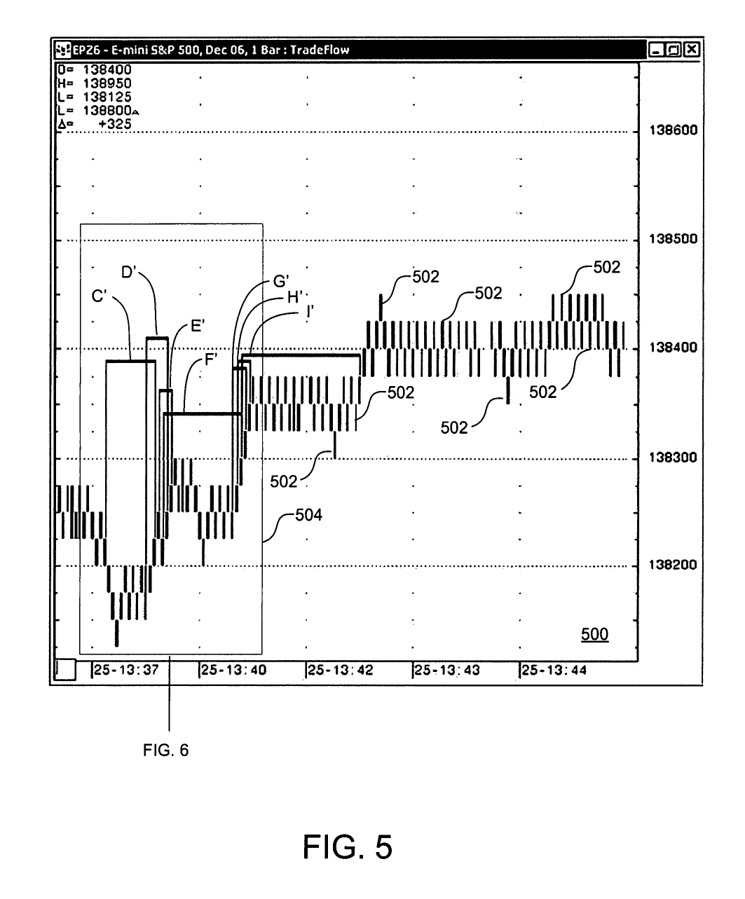

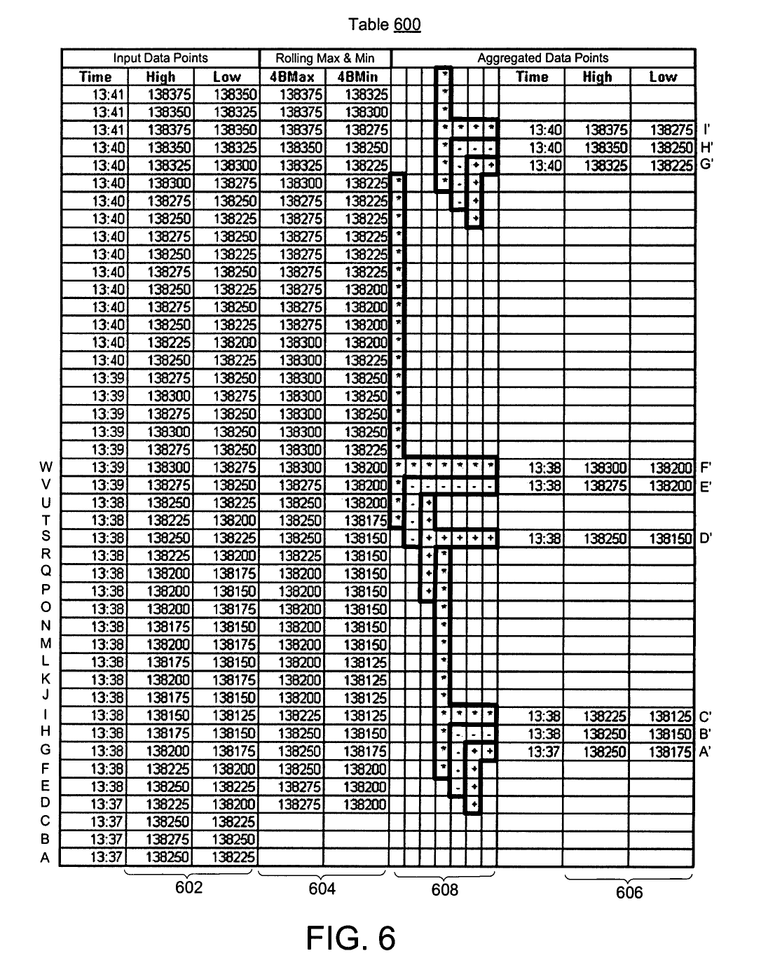

FIG. 3 illustrates a snapshot of a graphical user interface including an aggregated price bar chart 300. The aggregated price bar chart 300 includes a plurality of aggregated price bars 302 that have been generated from the input price bars 202 of FIG. 2. Using methods and systems described herein, one or more of the input price bars (see, e.g., FIGS. 2 and 5) and/or input data points (see, e.g., FIG. 6) that constitute purely horizontal, sideways price movement have been aggregated to smooth the data points and better illustrate the price trend. The rectangle 304 represents the portion of the bar chart illustrated by the aggregated data points in Table 400 in FIG. 4.

Turning to FIG. 5, there is again illustrated a snapshot of a graphical user interface including an exemplary price bar chart 500. The bar chart includes the same plurality of price bars 502 that are depicted in FIG. 2. The price bars 502 in FIG. 5 are referred to as “input bars” and the price data points depicted by the input bars are referred to as “input data points”. The input data points 602 used to generate the input bars of FIG. 5 are shown in Table 600 of FIG. 6.

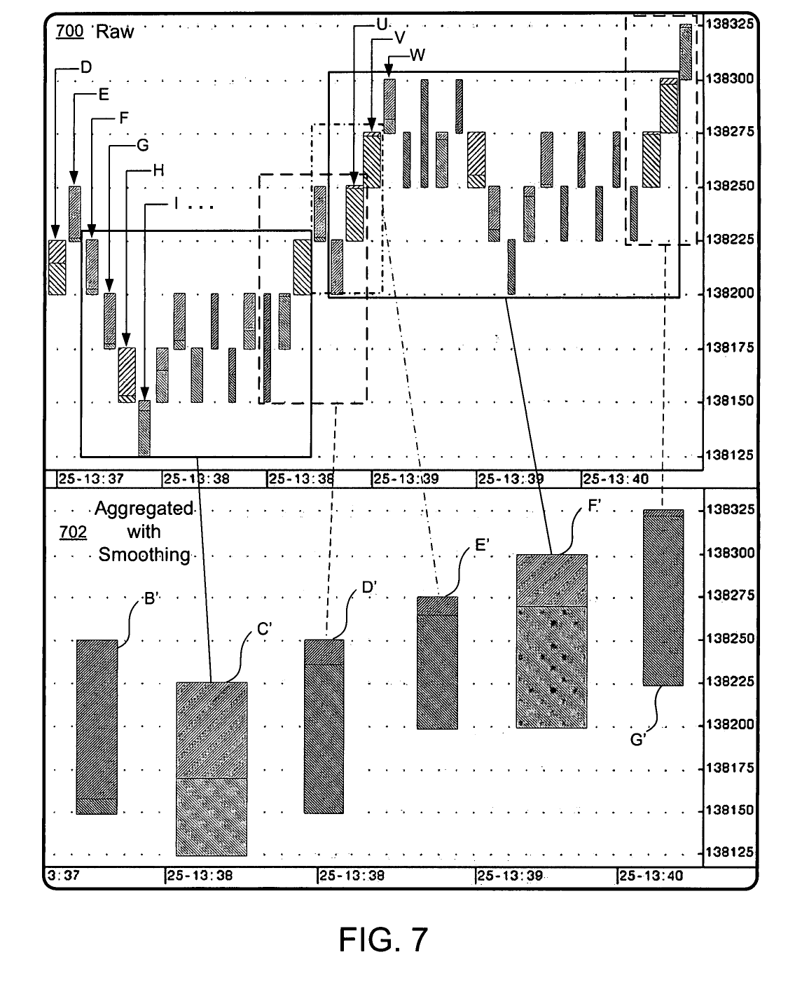

To demonstrate various embodiments for smoothing aggregation, FIG. 6 illustrates a table 600 including a set of input data points 602, a set of rolling minimum and maximum values 604, and a set of aggregated data points 606. Some of the data points are labeled with letters, such as A, B, C, D, E, F, G, H, I, J, K, L, M, N, O, P, R, S, T, U, V, W and A′, B′, C′, D′, E′, F′, G′, H′, I′ in order to illustrate an aggregation process with reference to FIGS. 3, 5 and 7. The prime letters (e.g., A′, B′, C′, etc.) refer to aggregated data points as illustrated in FIG. 4 and/or aggregated bars as illustrated in FIG. 3, while non-prime letters (e.g., A, B, C, etc.) refer to input data points and/or input bars as illustrated in FIGS. 5 and 7.

Box 504 of FIG. 5 illustrates the range of input bars that represent the input data points used to calculate the aggregated data points C′ through I′. To illustrate the aggregation process in more detail, FIG. 7 includes a smaller portion 700 of the input bar chart shown in FIGS. 2 and 5 as well as a smaller portion 702 of the aggregated bar chart shown in FIG. 3 constructed from data points calculated using smoothing techniques contemplated by embodiments of the present invention (discussed in greater detail below).

The embodiments shown in FIGS. 2-7 illustrate so-called “four bar smoothing” because four bars are used for reference, as will be demonstrated. In various embodiments, other numbers of bars/data points may be used for reference and/or for aggregation. In some embodiments, the user can set how many bars/data points are used for reference and/or aggregation. Using different numbers of input data points can result in different levels or degrees of smoothing. In accordance with four bar smoothing, the minimum and maximum values 604 are the minimum value and the maximum value in a rolling window of four successive input data points.

With more specific reference to FIG. 6, a starting input data point, such as input data point A (low=138225, high=138250), is selected. A reference set of input data points is selected to include input data points A, B, C, and D. It should be noted that the selected starting input data point may be arbitrary within a set of input data points. In addition, in some embodiments the starting input data point need not be included in the first reference set of input data points.

Referring again to the specific embodiment of FIG. 6, after a reference set consisting of the input data points A, B, C, and D is selected, an aggregation range is determined. The aggregation range is a high value and a low value. The aggregation range high value is set equal to the highest value among the input data points in the reference set, and the aggregation range low value is set equal to the lowest value among the input data points in the reference set. Thus, in the embodiment of FIG. 6, the aggregation range associated with reference input data points A, B, C, and D is (high=138275, low=138200). After the first reference set of input data points is selected and the associated aggregation range is determined, subsequent input data points are analyzed. When an input data point currently being processed represents an aggregation range extension, i.e. the high of the current input data point is greater than the reference high or the low of the current input data point is less than the reference low, and the current input data point is thus outside the range of the most recent reference set of input data points, a new aggregated data point is generated.

If the input data point being analyzed represents the first range extension then the first aggregated data point is initialized. Subsequently, when a range extension occurs, the currently aggregating data point is terminated and a new aggregation range is established for the next aggregated data point by selecting a new reference set. In one embodiment, the new aggregation range is set to the rolling maximum and minimum of the reference set that includes the current input data point being analyzed.

For example, in the embodiment illustrated, input data point E is analyzed. To illustrate, the analysis of input data point E involves determining whether input data point E is outside the aggregation range defined by the reference set A, B, C, and D. The high value of data point E, 138250, is compared to the aggregation range high value, 138275. In addition, the low value of data point E, 138225, is compared to the aggregation range low value, 138200. The high value of data point E is not greater than the high value of the aggregation range, and the low value of data point E is not less than the low value of the aggregation range defined by the reference set A, B, C, and D. Because the high and low values of data point E are not outside the aggregation range, the algorithm proceeds to process the next input data point, F. The high and low of the input data point F again fall within the current aggregation range, so the algorithm proceeds to process input data point G.

Continuing with the example, the high value of input data point G, 138200, is compared to the aggregation range high value, 138275 and the low value of input data point G, 138175, is compared to the aggregation range low value, 138200. The high value of input data point G is not greater than the high value of the aggregation range, but the low value of input data point G is less than the low value of the aggregation range defined by the reference set A, B, C, and D, so an aggregated data point A′ is initialized and a new aggregation range is established.

The aggregated data point A′ includes a high value and a low value. The high value of aggregated data point A′ is set equal to the current rolling maximum value, 138250, corresponding to the maximum value of the reference input data points D, E, F, and G. The low value of the aggregated data point A′ is set equal to the new low value set by input data point G. As such, in the illustrated example, the low value of the aggregated data point A′ is set equal to 138175, corresponding to the minimum value of the reference input data points D, E, F, and G.

Continuing on with the example illustrated in FIG. 6, the high value of the next input data point H, 138175, is compared to the aggregation range high value, 138250 and the low value of input data point H, 138150, is compared to the, aggregation range low value, 138200. The high value of input data point H is not greater than the high value of the aggregation range, but the low value of input data point H is less than the low value of the aggregation range defined by the current aggregated data point A′, so the aggregated data point A′ is terminated and an new aggregated data point B′ is initialized. The high value of new aggregated data point B′ is set equal to the current rolling maximum value, 138250, corresponding to the maximum of the reference input data points E, F, G, and H. The low value of the aggregated data point B′ is set equal to the new low value set by input data point H. As such, in the illustrated example, the low value of the aggregated data point B′ is set equal to 138150.

Continuing on with the example, the high value of the next input data point I, 138150, is compared to the aggregation range high value, 138250 and the low value of input data point I, 138125, is compared to the, aggregation range low value, 138150. The high value of input data point I is not greater than the high value of the aggregation range, but the low value of input data point I is less than the low value of the aggregation range defined by the current aggregated data point B′, so the aggregated data point B′ is terminated and an new aggregated data point C′ is initialized. The high value of new aggregated data point C′ is set equal to the current rolling maximum value, 138225, corresponding to the maximum of the reference input data points F, G, H, and I. The low value of the aggregated data point C′ is set equal to the new low value set by input data point I. As such, in the illustrated example, the low value of the aggregated data point C′ is set equal to 138125.

As is illustrated in FIG. 6, the analysis of input data points J through R does not yield a range extension, but when the high value of the input data point S, 138250, is compared to the aggregation range high value, 138225, the high value of input data point S is greater than the high value of the aggregation range, so the aggregated data point C′ is terminated and an new aggregated data point D′ is initialized. The high value of new aggregated data point D′ is set equal to the current rolling maximum value 138250, corresponding to the maximum of the reference input data points P, Q, R, and S. The low value of the aggregated data point C′ is set equal to the current rolling minimum value, corresponding to the minimum of the reference input data points P, Q, R, and S. As such, in the illustrated example, the low value of the aggregated data point D′ is set equal to 138150. In a similar manner, the algorithm rolls forward to yield aggregated data points E′, F′, G′, H′ and I′.

Columns 608 visually indicate the reference set used in determining the aggregation range and the length of series of consecutive data points that fall within the aggregation range. The symbols used, i.e., the “+”, “−”, and “*”, are used to indicate different iterations of generating an aggregated data point as they occurred on this data set. This type of visual depiction, may be useful in debugging implemented algorithms of various embodiments of the present invention.

The aggregated bar chart using the aggregated data points from FIG. 6 is illustrated in FIG. 3 and detailed in FIG. 7. A solid line box around input bars F through R in FIG. 7, and an arrow pointing to aggregated bar C′ below the input bars, illustrates that input data points F through R resolve to, and are replaced by, aggregated data point C′ in the smoothed bar chart 300. Similarly boxes with various line characteristics are drawn encompassing the input bars that represent the input data points that are aggregated to form the aggregated bars D′, E′, F′, G′, H′ and I′ as illustrated in FIG. 3.

The aggregation process continues through the plurality of data points 602 shown in FIG. 6, which correspond to the input bars 502 of FIG. 5. When completed the plurality of input bars 202 are presented more smoothly as aggregated bars 302 in FIG. 3. For example, the general upward trend between around time 25-13:38 and time 25-13:43 is shown as being relatively “jumpy” in input bar chart 200 of FIG. 2, but the upward trend is shown more smoothly in FIG. 3 with aggregated bars.

The rolling maximum and minimum values 604 illustrate only one mechanism for establishing a reference set and the corresponding aggregation range. In an alternative embodiment, the aggregation range for a new aggregated data point may be computed from a new reference data set as needed rather than by maintaining a continuous record of rolling maximums and minimums.

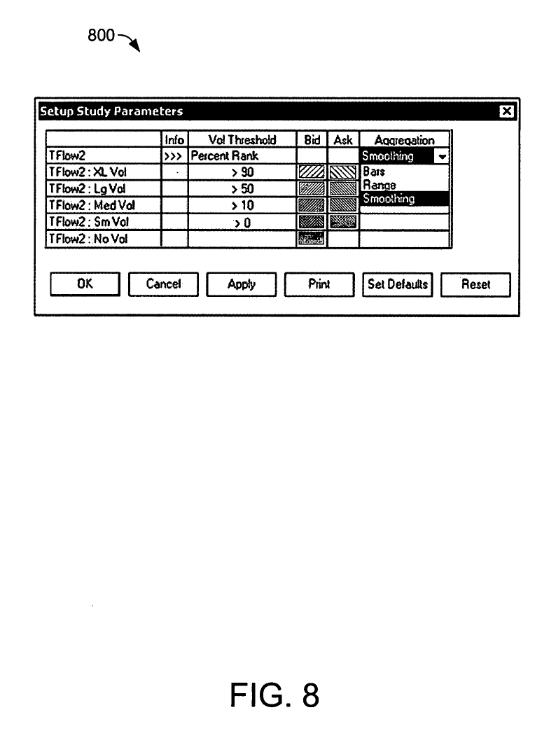

FIG. 8 illustrates a snapshot of an embodiment of a graphical user interface through which a user can select a type of aggregation. In the illustrated scenario, the user accesses a drop down menu, and is selecting “smoothing” aggregation. Other types of aggregation to select from include range and bars.

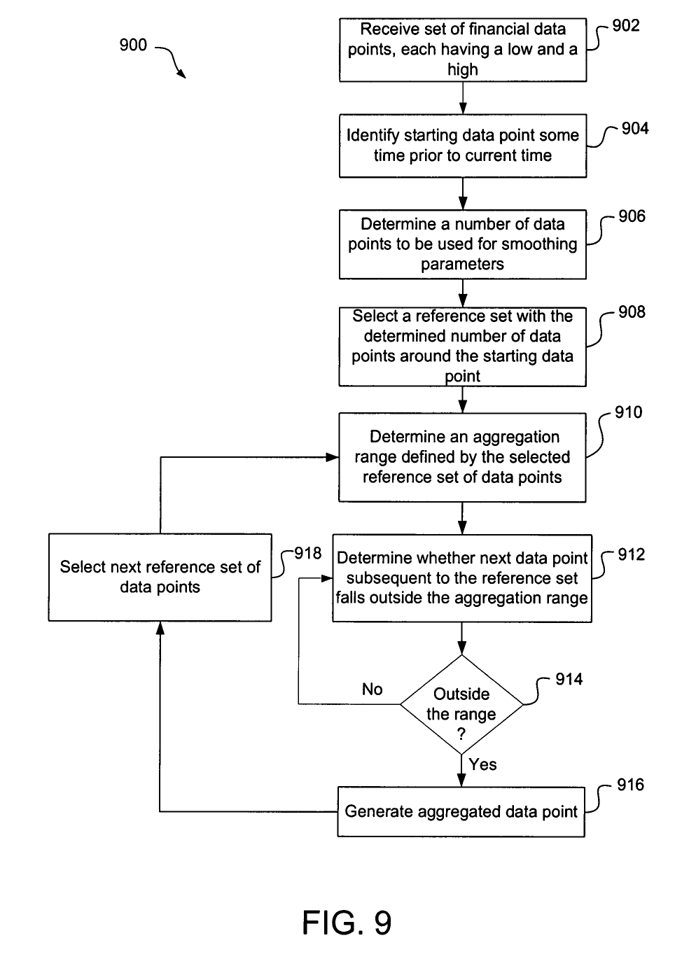

FIG. 9 is a flow chart illustrating one possible process 900 that can be carried out by a computer to perform smoothing aggregation according to at least one embodiment of the present invention, and can be executed with respect to a selected financial instrument that is traded on an exchange. During a receiving operation 902, a set of input price data points is received, wherein each data point includes a high price and a low price for the financial instrument. The input price data points may be algorithmically derived from a historical transaction database or from price and volume data streamed from a financial exchange or some other source.

Identifying operation 904 identifies a starting data point within the set of received data points. In at least one embodiment, the starting data point is a data point selected prior to the current time. A determining operation 906 then determines a number of data points to be used as a reference set of data points, which are used to set the smoothing aggregation ranges. In at least one embodiment, determining operation 906 refers to a value that has been specified by the user. The number of reference points specified by the user may vary widely, depending on the degree of smoothing desired. In various embodiments, the number of reference points may range from one to ten or more. In other embodiments, determining operation 906 determines the number of data points to be used in a dynamic fashion based on one or more of historical trends of the financial instrument, current trends of the financial instrument, volume data, user preferences, and or other criteria know to those of ordinary skill in the art. In some embodiments, the user may set a minimum and/or maximum number of points to be used in the reference set.

In a selecting operation 908, a reference set consisting of the number of input price data points determined by the determining operation 906 is selected near the starting data point. Determining operation 910 then determines an aggregation range associated with the reference set of input data points. In at least one embodiment, the aggregation range includes a high price equal to the highest price in the reference set, and a low price equal to the lowest price in the reference set. In other embodiments, the aggregation range may be scaled. For example, the high price may be set equal to the one hundred ten percent (110%) of the highest high price. Still yet, other embodiments, provide for the aggregation range to be extended, contracted, or shifted up and/or down by a constant value. The aggregation range may also be computed using other methods. For example, the highest price may be set equal to average of the highest price in the reference set plus two standard deviations of the highest prices in the reference set. Importantly, this list is only illustrative possible methods for computing and setting the aggregation range.

After the aggregation range is set, another determining operation 912 determines whether the next data point after the reference set of data points falls outside the aggregation range. This may involve comparing the high price and the low price of the next data point is higher or lower, respectively, than the high price and the low price of the aggregation range. A querying operation 914 queries for the result of the determining operation 912. If the next data point does not fall outside the aggregation range, the algorithm 900 branches “NO” to the determining operation 912, where a subsequent input data point is sequentially selected to determine if it falls within the aggregation range.

On the other hand, if the next data point does fall outside the aggregation range, the algorithm 900 branches “YES” to a generating operation 916. In the generating operation 916, an aggregated data point is generated with the determined aggregation range. In some embodiments, the generating operation 916 generates an aggregated data point that represents one or more of the data points in the reference set of data points and subsequent data points up to the next data point that falls outside the aggregation range defined by the reference set of data points. A selecting operation 918 then selects the next reference set of data points, and the algorithm 900 returns to the determining operation 910, which determines the aggregation range of the next reference set.

Whereas the description of the method of this invention above is in terms of a set of input data points computed for a historical database of financial transactions, the input data points may also be received in real-time as they are computed from real-time financial transactions.

Exemplary Computing Device

Embodiments of the present invention include various steps and components, which are described herein. The steps and/or components may be related to hardware or may be embodied in machine-executable instructions, which may be used to cause a general-purpose or special-purpose processor programmed with the instructions to perform the steps. Alternatively, they may be (and/or be performed by) a combination of hardware, software, firmware or human parties involved in the transaction.

Embodiments of the present invention may be provided at least in part as a computer program product, which may include a machine-readable medium having stored thereon instructions, which may be used to program a computer (or other electronic devices) to perform a process. The machine-readable medium may include, but is not limited to, floppy diskettes, optical disks, compact disc read-only memories (CD-ROMs), and magneto-optical disks, ROMs, random access memories (RAMs), erasable programmable read-only memories (EPROMs), electrically erasable programmable read-only memories (EEPROMs), magnetic or optical cards, flash memory, or other type of media/machine-readable medium suitable for storing electronic instructions. Moreover, embodiments of the present invention may also be downloaded as a computer program product, wherein the program may be transferred from a remote computer to a requesting computer by way of data signals embodied in a carrier wave or other propagation medium via a communication link (e.g., a modem or network connection).

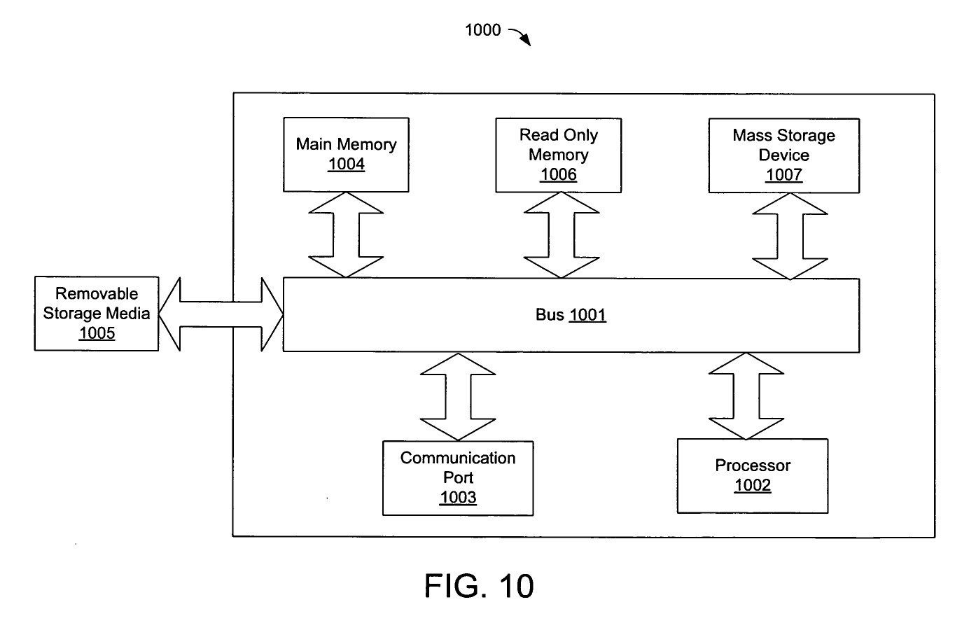

FIG. 10 is a schematic diagram of a computing device 1000 upon which a server or client side financial trading and/or analysis application may execute. According to the present example, the computing device 1000 includes a bus 1001, at least one processor 1002, at least one communication port 1003, a main memory 1004, a removable storage media 1005 a read only memory 1006, and a mass storage 1007. Processor(s) 1002 can be any know processor, such as, but not limited to, an Intel® Itanium® or Itanium 2® processor(s), or AMD® Opteron® or Athlon MP® processor(s), or Motorola® lines of processors. Communication port(s) 1003 can be any of an RS-232 port for use with a modem based dialup connection, a 10/100 Ethernet port, or a Gigabit port using copper or fiber. Communication port(s) 1003 may be chosen depending on a network such a Local Area Network (LAN), Wide Area Network (WAN), or any network to which the computing device 1000 connects. The computing device 1000 may be in communication with peripheral devices (not shown) such as, but not limited to, printers, speakers, cameras, microphones, or scanners.

Main memory 1004 can be Random Access Memory (RAM), or any other dynamic storage device(s) commonly known in the art. Read only memory 1006 can be any static storage device(s) such as Programmable Read Only Memory (PROM) chips for storing static information such as instructions for processor 1002. Mass storage 1007 can be used to store information and instructions. For example, hard disks such as the Adaptec® family of SCSI drives, an optical disc, an array of disks such as RAID, such as the Adaptec family of RAID drives, or any other mass storage devices may be used.

Bus 1001 communicatively couples processor(s) 1002 with the other memory, storage and communication blocks. Bus 1001 can be a PCI/PCI-X or SCSI based system bus depending on the storage devices used. Removable storage media 1005 can be any kind of external hard-drives, floppy drives, IOMEGA® Zip Drives, Compact Disc-Read Only Memory (CD-ROM), Compact Disc—Re-Writable (CD-RW), Digital Video Disk-Read Only Memory (DVD-ROM).

Various modifications and additions can be made to the exemplary embodiments discussed without departing from the scope of the present invention. For example, while the embodiments described above refer to particular features, the scope of this invention also includes embodiments having different combinations of features and embodiments that do not include all of the described features. Accordingly, the scope of the present invention is intended to embrace all such alternatives, modifications, and variations together with all equivalents thereof.

While, for convenience, embodiments of the present invention are described herein with reference to specific data processing algorithms, bid/ask range charts, bid/ask volume charts and specific user interface screens for trading financial instruments in the form of dynamic price scales, the techniques described are equally applicable to various other types and structures of charts and trading paradigms.

What is claimed is:

1. A computer-implemented method for aggregating price data of a financial instrument comprising:
receiving a set of financial data points for the financial instrument, wherein each financial data point in the set includes a low price and high price for the financial instrument;
selecting a reference set that includes a subset of financial data points from the set of financial data points;
defining smoothing aggregation parameters based on the selected reference set of financial data points;
selecting a series of consecutive financial data points subsequent to the reference set, wherein the series of consecutive financial data points is defined by consecutive financial data points subsequent to the reference set that fall inside the defined smoothing aggregation parameters; and
generating an aggregated data point when one of the consecutive financial data points subsequent to the reference set falls outside the smoothing aggregation parameters, wherein the aggregated data point is based on the selected series of consecutive financial data points and the smoothing aggregation parameters.

2. The computer-implemented method of claim 1, further comprising selecting a new reference set for a new aggregated data point to be generated.

3. The computer-implemented method of claim 1, further comprising identifying a starting data point that is within the set of financial data points and has an associated time value before a current time value.

4. The computer-implemented method of claim 3, wherein the reference set is selected by taking a number of consecutive financial data points after the starting data point.

5. The computer-implemented method of claim 4, wherein the reference set comprises a user defined number of financial data points.

6. The computer-implemented method of claim 1, further comprising updating a chart displayed on a display device by adding a graphical representation of the aggregated data point on the chart.

7. The computer-implemented method of claim 1, further comprising:
determining a trade volume associated with each of the financial data points in the series of consecutive financial data points;
determining a total volume value by summing the trade volume of each of the financial data points in the series of consecutive financial data points; and
displaying a bar representing the aggregated data point on a bar chart, wherein the bar representing the aggregated data point has a width proportional to the total volume.

8. The computer-implemented method of claim 1, further comprising:
determining a bid trade volume and an ask trade volume associated with each of the financial data points in the series of consecutive financial data points, wherein the bid trade volume is a volume traded at the bid and the ask trade volume is a volume traded at the ask;
determining an aggregated bid trade volume and an aggregated ask trade volume by summing the bid trade volume and ask trade volume of each of the financial data points in the series of consecutive financial data points; and
displaying a bar representing the aggregated data point on a bar chart, wherein the bar representing the aggregated data point is colored with a color associated with a ratio of the bid trade volume to the ask trade volume.

9. The computer-implemented method of claim 1, wherein the smoothing aggregation parameters include an aggregation range and wherein determining if a first financial data point subsequent to the reference set falls inside the defined smoothing aggregation parameters includes determining if the high price and the low price associated with the first financial data point are inside the aggregation range.

10. The computer-implemented method of claim 1, further comprising:
determining a high aggregation value corresponding to a highest value of the highest price associated with the financial data points in the reference set;
determining a low aggregation value corresponding to a lowest value of the lowest price associated with the financial data points in the reference set; and
wherein the smoothing aggregation parameters include an aggregation range between the high aggregation value and the low aggregation value.

11. The computer-implemented method of claim 1, further comprising:
receiving a data set of order and trade information from an electronic exchange; and
generating the set of financial data points for the financial instrument from the data set of order and trade information received from the electronic exchange.

12. The computer-implemented method of claim 1, wherein the set of financial data points for the financial instrument includes financial data points that have been filtered through a pre-processing algorithm that generates price bar data.

13. A system for presenting aggregated financial data, the system comprising:
a display device operable to display a graphical interface;
a display input/output device in communication with the display device;
a microprocessor in communication with the display input/output device and operable to execute instructions stored in memory that when executed cause the microprocessor to select a reference set of financial data points from a set of financial data points, define one or more smoothing aggregation parameters based on the reference set, and select a series of consecutive financial data points subsequent to the reference set of financial data points that meet the one or more smoothing aggregation parameters; and
the microprocessor executable instructions further causing the microprocessor to generate an aggregated data point when a financial data points subsequent to the reference set does not meet the one or more smoothing aggregation parameters and communicate the aggregated data point to the display device.

14. The system of claim 13, wherein the instructions stored in memory further cause the microprocessor to update a chart displayed on the display device by adding a graphical representation of the aggregated data point on the chart.

15. The system of claim 13, wherein the instructions stored in memory to cause the microprocessor to define one or more smoothing aggregation parameters based on the reference set causes the microprocessor to determine an aggregation range associated with the reference set of financial data points with a high value equal to a highest price in the reference set of financial data points and a low value equal to a lowest price in the reference set of financial data points.

16. The system of claim 13, wherein the microprocessor is communicably coupled to an electronic exchange and includes instructions to receive the set of financial data points from the electronic exchange.

17. The system of claim 13, wherein the set of financial data points for the financial instrument is received from a pre-processing algorithm that generates price bar data.

18. The system of claim 13, wherein the reference set is selected by selecting at least four consecutive financial data points after a beginning of a trading session.

19. A computer-readable storage medium containing a set of instructions capable of causing one or more processors to:
select a reference set that includes one or more financial data points;
define smoothing aggregation parameters based on the selected reference set of financial data points;
select a series of financial data points subsequent to the reference set, wherein the series of financial data points is defined by consecutive financial data points subsequent to the reference set that fall inside the defined smoothing aggregation parameters; and
generate an aggregated data point based on the selected series of financial data points when a financial data points subsequent to the reference set falls outside the defined smoothing aggregation parameters.

20. The computer-readable storage medium of claim 19, wherein the set of instructions are further capable of causing one or more processors to update a chart displayed on a display device by adding a graphical representation of the aggregated data point on the chart.
